(19) United States
(12) Patent Application Publication
(10) Pub. No.: US 2016/0306368 A1
(43) Pub. Date: Oct. 20, 2016

(54) Advisor Recipe Development Software (ARDS)

(71) Applicants: Bayer MaterialScience, LLC, Pittsburgh, PA (US); Bayer MaterialScience AG, Leverkusen (DE)

(72) Inventors: Keith Spitler, Burgettstown, PA (US); David Steppan, Gibsonia, PA (US); Joachim Werner, Cologne (DE)

(73) Assignees: Bayer MaterialScience, LLC; Bayer MaterialScience AG

(21) Appl. No.: 14/686,218

(22) Filed: Apr. 14, 2015

(51) Int. Cl. G05D 11/13

(52) U.S. Cl. CPC G05D 11/135; G05B 2219/32287

(57) ABSTRACT

A computer-implemented method for advisor recipe development is disclosed. According to the method, a processor receives a first component and identifies enhanced context specific information based on the selection of the first component. The context specific information is updated interactively when adding a second component, and/or additional components, to the first component. The context specific information may include text, tables, or charts and combinations thereof.

### BACKGROUND OF THE INVENTION

Traditional product recipe development systems require a user to specify a recipe by picking from pre-defined lists of base components. The lists are typically sorted alphabetically by name and/or type. Traditional systems display all of the components stored by the system without providing any information regarding the use of a selected component with one or more additional components.

In addition, traditional systems require the user to make an assumption about the type of formulation to be developed prior to the generation process. The user must understand which components they are interested in, as traditional systems fail to provide contextual information regarding selected components and/or combinations of components. Traditional systems further fail to identify whether the current formulation is duplicating work conducted by other members of an organization.

### SUMMARY OF THE INVENTION

In various embodiments, a computer-implemented method for advisor recipe development is disclosed. The method comprises: receiving, by a processor, a first component; and identifying, by the processor, enhanced context specific information based on the first component.

In various embodiments, an advisor recipe development system is disclosed. The advisor recipe development system comprises a processor and a non-transitory computer-readable medium coupled to the processor. The non-transitory computer-readable medium is configured to store computer program instructions that when executed by the processor are operable to cause the processor to: receive a first component; and identify enhanced context specific information based on the first component.

In various embodiments, a computer-implemented method for advisor recipe development is disclosed. The method comprises: receiving, by a processor, a first component; receiving, by the processor, a second component; and identifying, by the processor, enhanced context specific information based on the first component and the second component.

### BRIEF DESCRIPTION OF THE FIGURES

The features of the various embodiments are set forth with particularity in the appended claims. The various embodiments, however, both as to organization and methods of operation, together with advantages thereof, may best be understood by reference to the following description, taken in conjunction with the accompanying drawings as follows:

FIG. 1 illustrates one embodiment of a process for advisor recipe development;

FIG. 2 illustrates one embodiment of a process for generating a new formulation utilizing an advisor recipe development;

FIG. 3 illustrates one embodiment of an advisor recipe development system screen;

FIG. 4 illustrates one embodiment of a component selection screen;

FIG. 5 illustrates one embodiment of the component selection screen updated after the selection of an isocyanate;

FIG. 6 illustrates one embodiment of an enhanced context-specific information screen configured to display component inventory information;

FIG. 7 illustrates one embodiment of an enhanced context-specific information screen configured to display formulation ownership information;

FIG. 8 illustrates one embodiment of an enhanced context-specific information screen configured to display physical properties information screen;

FIG. 9 illustrates one embodiment of a component selection screen configured to display polyols;

FIG. 10 illustrates one embodiment of the component selection screen modified based on the selection of a polyol by the user;

FIG. 11 illustrates one embodiment of the component selection screen modified based on the selection of a second polyol by the user;

FIG. 12 illustrates one embodiment of the component selection screen configured to display catalyst;

FIG. 13 illustrates one embodiment of the component selection screen configured to display blowing agents;

FIG. 14 illustrates one embodiment of a component selection screen configured to display components used in a selected project;

FIG. 15 illustrates one embodiment of a computer system configured to implement an advisor recipe development system.

### DETAILED DESCRIPTION OF THE INVENTION

Reference will now be made in detail to several embodiments, including embodiments showing example implementations of an advisor recipe development platform and method. Wherever practicable similar or like reference numbers may be used in the figures and may indicate similar or like functionality. The figures depict example embodiments of the disclosed systems and/or methods of use for purposes of illustration only. One skilled in the art will readily recognize from the following description that alternative example embodiments of the structures and methods illustrated herein may be employed without departing from the principles described herein.

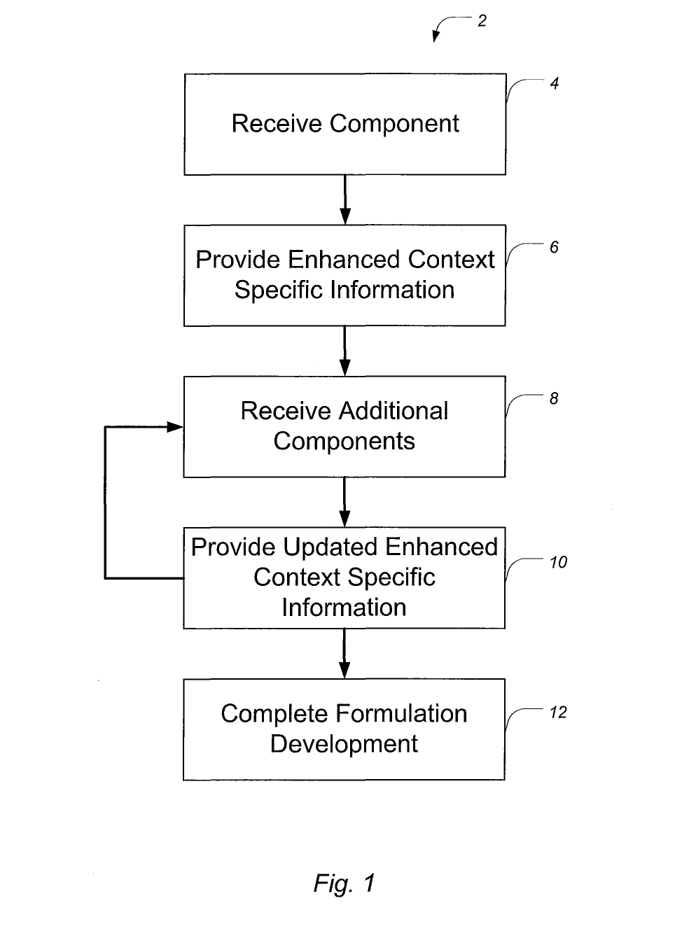

FIG. 1 illustrates one embodiment of a computer-implemented process 2 for advisor recipe development. The computer-implemented process 2 enables selection of a plurality of components to generate a formulation. A component may comprise a chemical component, a chemical, a chemical material, a raw material, a compound, and/or any other suitable material for inclusion in a formulation. A formulation may comprise a chemical formulation, recipe, compound, and/or any other suitable combination of components. In one embodiment, a user selects 4 a first component to be added to a formula being developed by the user. The user selects 4 the first component from a list of components. The list of components may comprise a sorted list, such as, for example, an alphabetically sorted list. The list of components may be sorted by name and/or type of component. In some embodiments, the list of components may be sorted by user-defined criteria, such as, for example, the most used component, available components, and/or other user-defined criteria.

In some embodiments, the list of components may be limited to a specific dictionary of components. For example, dictionaries of components may comprise catalysts, binders, fillers, blowing agents, and/or other groupings of components. A limited list of components may be presented based on the dictionary selected by the user. The limited list of components may be sorted as discussed above, such as, for example, sorting the components alphabetically based on the name and/or type of the component.

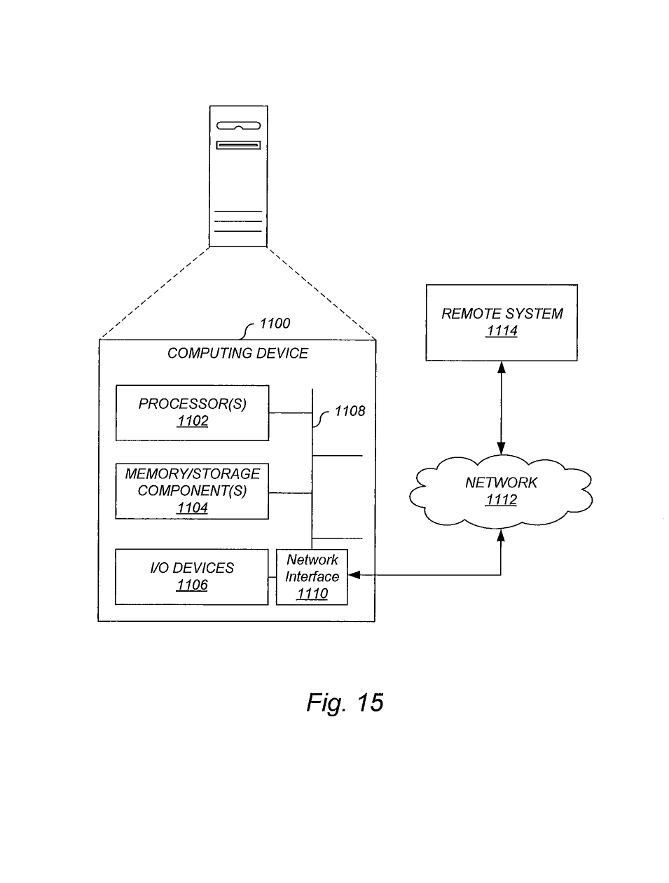

The selection of the first component may be provided to an external device, system, or process by a processor, such as the processing unit 1102 discussed hereinbelow in connection with FIG. 15. Referring back to FIG. 1, the processor may provide 6 enhanced context specific information regarding the first component to the user. For example, the enhanced context specific information may comprise: one or more lists of additional components used in existing formulations with the first component; relevant component information for the first component; primary information relating to the first component; and/or secondary information relating to the first component. In some embodiments, the type of enhanced context specific information provided 6 for the first component may be based on the type of component selected, may be defined by the user, and/or may be defined by a user association, such as, for example, the project group to which the user is assigned.

In some embodiments, the enhanced context specific information may comprise one or more lists of additional components used in existing formulations with the first component. The one or more lists of additional components may comprise information related to the use of the additional components with the selected component, such as, for example, frequency of use and quantity of use information. The frequency of use information may indicate the number of formulations in which the additional component has been paired with the selected component. The quantity of use information may indicate the typical amount of an additional component used in formulations with the first component. The one or more lists of additional components may be sortable by frequency of use, quantity of use, and/or other factors.

In some embodiments, the enhanced context specific information may comprise relevant component information related to the first component. For example, the relevant component information may comprise the chemical structure of the first component, the manufacturer's specifications regarding the first component, the Material Safety Data Sheet (MSDS) code for the first component, the Enterprise Resource Management (ERP) code, and/or other component information for the first component. The relevant component information may be defined by a user, an organization, and/or an outside body, such as, for example, a standards setting body.

In some embodiments, the enhanced context specific information may comprise primary information related to the first component. For example, such primary enhanced context specific information may comprise processing and performance metrics (for example, physical testing results), formulation development objectives, and/or statistical moments of data related to recipes containing the first component, such as, for example, mean and standard deviation related to testing or performance of the component in a recipe containing the first component. In some embodiments, this primary information may be sorted, for example, by decreasing frequency.

In some embodiments, the enhanced context specific information may comprise secondary information related to the first component. For example, such secondary information may comprise scale-up trial data, commercial product data, and support document data relating to the first component in a recipe containing the first component. The secondary information may be sorted, for example, by date of the information.

The processor may receive 8 a second component selected by a user to include in the formulation being developed. The second component may be selected from the one or more lists of components provided by the enhanced context specific information to the user. In some embodiments, a user may base the selection of the second component on the enhanced context specific information provided by the system. After receiving 8 the additional component, the system may provide 10 updated enhanced context specific information to the user based on the combination of the first component and the second component. The updated enhanced context information may provide 10, for example, the same type of information as provided 6 for the first component, additional information as that provided 6 for the first component, or different contextual information as that provided 6 for the first component.

In some embodiments, the enhanced context specific information provided 10 for the selection of two or more components may comprise one or more lists of additional components. The one or more lists of additional components may present additional components commonly and/or previously used with the first component and the second component, such as, for example, frequency of use and quantity of use information. The frequency of use information may indicate the number of formulations in which the additional component has been paired with the combination of the first component and the second component. The quantity of use information may indicate the typical amount of the additional component used in formulations with the combination of the first component and the second component. The one or more lists of additional components may be sortable by frequency of use, quantity of use, and/or other factors.

In some embodiments, the enhanced context specific information may comprise relevant information related to the formulation comprising the first component and the second component. For example, the relevant information may comprise the chemical structure of the formulation, the manufacturer's specifications regarding the formulation and/or the constituent components of the formulation, the Material Safety Data Sheet (MSDS) code for the selected components and/or the formulation, the Enterprise Resource Management (ERP) code for the selected components and/or the formulation, and/or other formulation information. The relevant information may be defined by a user, an organization, and/or an outside body, such as, for example, a standards setting body.

In some embodiments, the enhanced context specific information may comprise formulation specific information. The formulation specific information may identify an owner/original creator of a formulation and/or formulations containing the first and second components, contact information for the owner/creator of the one or more formulations, and/or a count of formulations including the first and second components. In some embodiments, the formulation specific information may be limited to formulations developed within a specific organization. In other embodiments, the formulation specific information may include information for all known formulations including the first and second components.

In some embodiments, the enhanced context specific information may comprise primary information related to the formulation and/or the first and second components. For example, this primary enhanced context specific information may comprise processing and performance metrics (for example, physical testing results), development objectives related to the formulation, the first component, and/or the second component, and/or statistical moments of data related to the formulation, such as, for example, mean and standard deviation related to testing or performance of the formulation and/or formulations containing the first and second components. In some embodiments, the primary information may be sorted, for example, by decreasing frequency.

In some embodiments, the enhanced context specific information may comprise secondary information related to the selected formulation and/or the first and second components. For example, the secondary information may comprise scale-up trial data, commercial product data, and/or support document data relating to the first component, the second component and/or the combination of the first and second components. The secondary information may be sorted, for example, by the date that the information was produced. The user may complete 12 the generation of a new formulation by saving and/or otherwise finalizing the formulation.

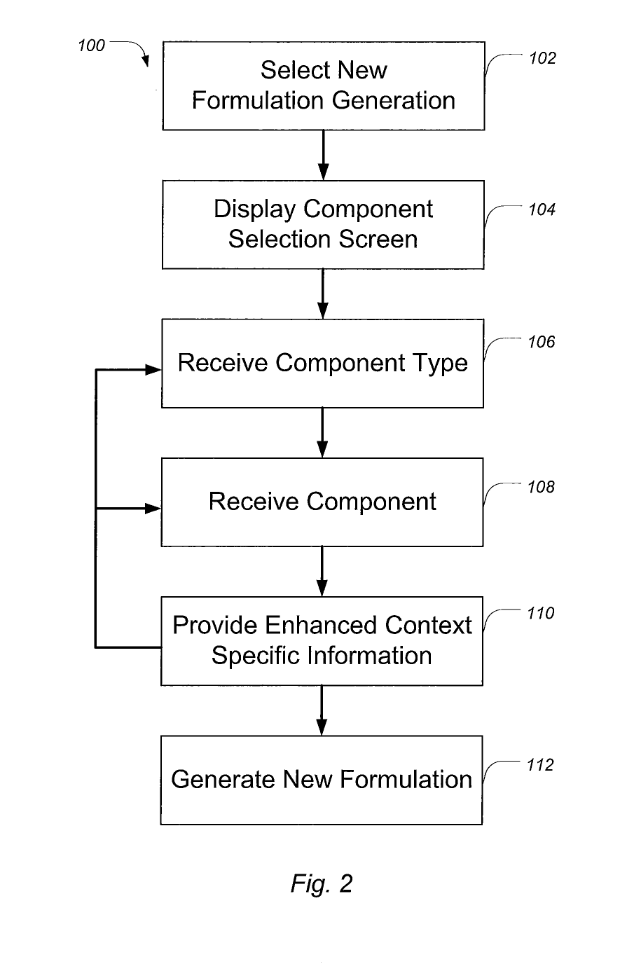

FIG. 2 illustrates one embodiment of a process 100 for developing a formulation using an advisor recipe development system. The advisor recipe development system may generate a new formulation with information obtained from a user interacting with the system. For example, the processor may receive 102 a new formulation option selected by the user from a graphical user interface presented by the advisor recipe development system. The advisor recipe development system may display 104 a component selection screen to the user. The component selection screen may comprise one or more lists of components. In some embodiments, the component selection screen may allow a user to select a type of component to be displayed. For example, the component selection screen may comprise one or more component type buttons configured to select a category or type of component, such as, for example, polyols, isocyanates, catalysts, fillers, and/or blowing agents. Accordingly, the processor may receive 106 the type of component to be displayed selected by the user.

In some embodiments, the component selection screen may comprise a component selection list. The component selection list may display one or more components matching the category of component selected by a user. For example, in one embodiment, when isocyanates are selected and received by the processor as the component category, the component selection list may display one or more isocyanates. The component selection list may indicate the number of times that the specific component has been used in a formulation, the average amount of the component used in formulations, and/or additional information about the component. The component selection list may organize the displayed components, for example, alphabetically, based on frequency of use, and/or based on one or more additional sorting criteria.

A user may select a first component from the component selection list and that selection may be received 108 by the processor. After receiving 108 the first component selection, the advisor recipe development system may provide 110 enhanced context specific information based on the selection of the first component to a display and/or may communicate the enhanced context specific information to other systems and/or processors. The enhanced context specific information may comprise, for example, one or more lists of components used with the first component in existing formulations, relevant information, primary information relating to the first component, and/or secondary information relating to the first component.

In some embodiments, the enhanced context specific information may comprise organizational specific information. For example, the enhanced context specific information may comprise inventory information identifying the current quantities and/or locations of the first component within an organization, usage information identifying people within the organization that have used the first component, and/or a list of projects within the organization that have used the first component. The enhanced context specific information may provide information relating to the number of formulations that include the first component associated with a person and/or project.

In some embodiments, the enhanced context specific information may comprise component specific information, such as, for example, a list of physical properties that have been measured for the first component and/or formulations using the first component. For example, the list of physical properties may comprise density, thermal conductivity, compression strength, shore D hardness, tensile strength, and/or other physical properties. In some embodiments, the enhanced context specific information may comprise the average processing conditions for formulations including the first component.

In some embodiments, the component selection list may be updated based on the selection of the first component. For example, the component selection list may be updated to display only those components from the selected component category that have been used in previous formulations with the first component. When a user wishes to add a second component from the same component category as the first component, the user may select a second component from the component selection list. The user may select a different component category by selecting one of the one or more component selection buttons. When a user selects a different component category, the system may update the component selection list to display components from the selected component category that have been used in formulations with the first component.

The user may select a second component from the component selection list and that selection may be received 108 by the processor. The second component may comprise a component identified by the system as being used in existing formulations with the first component. In some embodiments, the second component may comprise a component not previously used with the first component. The component not previously used may be provided 110 to a display, for example, or may be communicated to other systems and/or processors. After receiving 108 the second component selection, the system may provide 110 enhanced context specific information related to the combination of the first component and the second component. The enhanced context specific information may comprise one or more lists of components used with the combination of the first component and the second component in existing formulations, relevant component/formulation information, formulation ownership information, primary information relating to the combination of the first component and the second component, and/or secondary information relating to the combination of the first component and the second component.

In some embodiments, the enhanced context specific information may comprise organization specific information. For example, the enhanced context specific information may comprise inventory information identifying the current quantities and locations of the first component, the second component, or a combination of the first and second component within the organization, usage information identifying people within the organization that have used the first component, the second component, or the combined first and second components, and/or a list of projects within the organization that have used the first component, the second component, and/or the combined first and second component. The enhanced context specific information may provide information relating to the number of formulations that include the first component, the second component, and/or the combination of the first and second components associated with a person and/or project.

In some embodiments, the enhanced context specific information may comprise component specific information, such as, for example, a list of physical properties that have been measured for the first component, the second component, and/or formulations using the first and second components. For example, the list of physical properties may comprise density, thermal conductivity, compression strength, shore D hardness, tensile strength, and/or other physical properties. In some embodiments, the enhanced context specific information may comprise the average processing conditions for formulations including the first and second components.

In some embodiments, the enhanced context specific information may comprise component information developed internally and/or by an outside organization, such as, for example, processing and performance metrics, formulation development objectives, moments of data including, for example, standard deviations, means, and/or other statistical data. The enhanced context specific information may further comprise data related to scale-up trials, commercial products, and/or detailed support documents.

In some embodiments, the enhanced context specific information may comprise graphical data feedback. For example, if a user selects a first component and a second component, a graph of hardness and/or elongation as a function of the amount of the second component in the formulation may be displayed to the user. The graphical data feedback may be provided by one or more displays, such as, for example, liquid crystal displays (LCD), cathode ray tube (CRT) displays, three-dimensional (3D) displays, holographic displays, or any other suitable display type.

The user may select one or more additional components from the component selection list, which may be received 106 by the processor. The component selection list may be updated and/or limited based on the selection of the second component and the one or more additional components. After each additional component is selected, the system may update the enhanced context specific information to comprise components including each of the selected components and/or information related to each of the individual components. A user may continue to add components from the component selection list until the user has generated a satisfactory formulation.

In some embodiments, the user may remove one or more components from the selected components, which may then be received by the processor. The user may select a component from a selected components list and may remove the selected component from the formulation. The system may update the components selection list and the enhanced context specific information to reflect the removal of a component. In some embodiments, each component is deleted in the order in which the components were added to the formulation. For example, when a first component, a second component, and a third component are selected, the user may be required to remove the third component before removing the second component. In some embodiments, the user can remove a component without removing subsequently selected components.

In some embodiments, the component selection list may be modified by selecting information included in the enhanced context specific information. For example, a user may select displayed enhanced context specific information relating to members of an organization who have used the selected components in one or more projects. The component selection list may be updated to display only those components used by a selected member of the organization in conjunction with the previously selected components. The system may allow a user to limit the component selection list based on additional enhanced context specific information, such as, for example, a list of projects in which the selected components were used, available components within the organization/at a specific location, and/or other enhanced context specific information.

In some embodiments, the advisor recipe development system comprises asynchronous communication with the processor. For example, the advisor recipe development system may comprise a multi-threaded process in which subsequent threads or communication calls cancel previous calls to the processor. By cancelling previous calls, the advisor recipe development system provides relevant and live information for the current selections of a user. For example, in one embodiment, if a user rapidly selects components for inclusion in a formulation, each subsequent component selection initiates generation of context specific information that includes all currently selected materials and cancels the previous request for context specific information. In other embodiments, the advisor recipe development system comprises synchronous communication with a processor. In this embodiment, each call for context specific information is completed before the next request is processed.

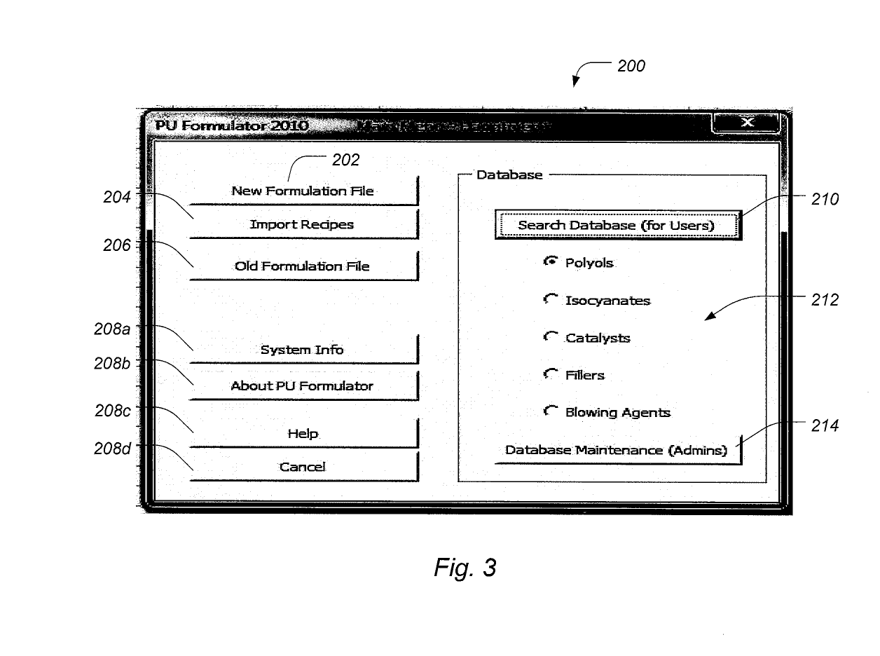

FIG. 3 illustrates one embodiment of an advisor recipe development system start screen 200. The advisor recipe development system start screen 200 may comprise one or more virtual buttons to allow a user to interact with the advisor recipe development system. For example, in some embodiments, a “New Formulation File” virtual button 202 may be configured to begin a process for generating a new formulation. An “Import Recipes” virtual button 204 may be configured to load one or more predetermined formulations from a storage location, such as, for example, a database or local storage. An “Old Formulation File” virtual button 206 may be configured to import one or more saved formulation files previously developed by the system. The saved formulation files may be saved, for example, locally on a user's system, in a central database, and/or on a removable memory medium.

The advisor recipe development system start screen 200 may further comprise one or more system interaction virtual buttons 208a-208d. The system interaction virtual buttons 208a-208d may provide a user with additional system interaction options unrelated to the generation of formulations. For example, a “System Info” virtual button 208a may provide information regarding the advisor recipe development system, such as, for example, the technical specifications of the system, the connected databases, and/or additional system information. An “About PFU Formulator” virtual button 208b may identify information about the advisor recipe development software executed by the system, such as, for example, the version number or build number. A “Help” virtual button 208c may be configured to provide instructions or help regarding the use of the advisor recipe development system. A “Cancel” virtual button 208d may be configured to exit the advisor recipe development system.

In some embodiments, the advisor recipe development system start screen 200 may be configured to allow one or more databases to be searched for users and/or formulations based on, for example, the type of component associated with the formulations. For example, in the illustrated embodiments, a search 210 may be conducted in a user database for additional users associated with a specific category of component 212, such as, for example, polyols, isocyanates, catalysts, fillers, and/or blowing agents. A “Database Maintenance” virtual button 214 may be configured to allow an administrator to update, modify, and/or remove one or more databases from the search option.

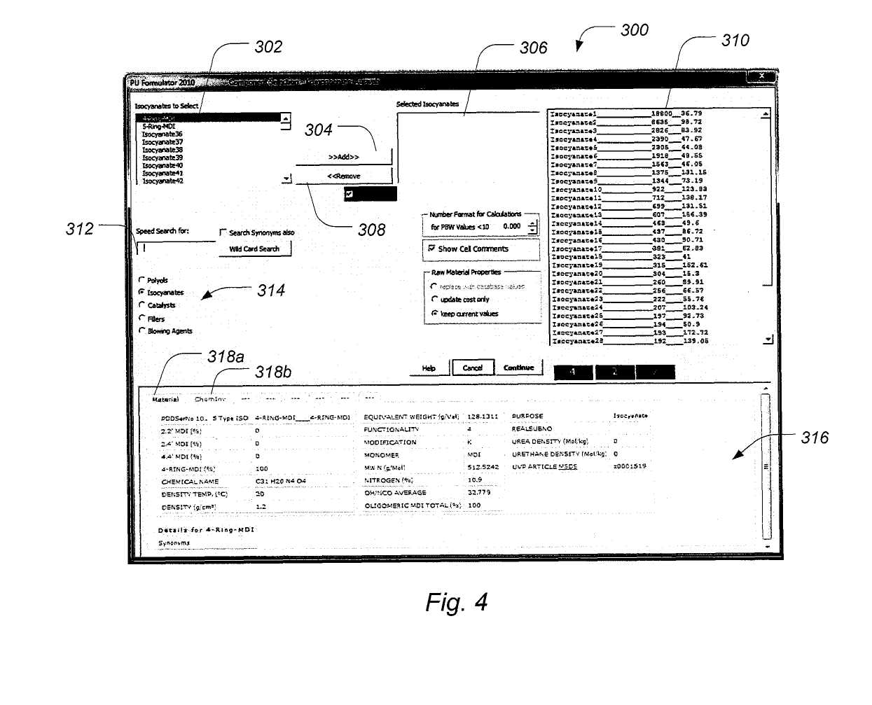

In one embodiment, a user may select the “New Formulation File” virtual button 202 to begin generation of a new formulation, such as, for example, a chemical formulation. After selecting the “New Formulation File” virtual button 202, the advisor recipe development system may display a component selection screen, such as, for example, the component selection screen 300 illustrated in FIG. 4. The component selection screen 300 may comprise one or more areas for selecting one or more components to be added to a formulation. For example, the component selection screen 300 may comprise a component selection list 302 configured to display components classified in a specific category of components. A category selection list 314 may be configured to allow a user to select predefined categories of components. For example, in one embodiment, the category selection list 314 may comprise predefined categories such as polyols, isocyanates, catalysts, fillers, and blowing agents. An “Add” virtual button 304 may be configured to add a selected component from the component selection list 302 to the selected components list 306. A “Remove” virtual button 308 may be configured to remove a selected component from selected components list 306. In some embodiments, components may be removed from the selected components list 306 in the reverse order in which the components were added. In other embodiments, the components may be removed from the selected components list 306 in any order.

In some embodiments, the component selection screen 300 may comprise a dynamic component list 310. The dynamic component list 310 may be configured to display components from the selected category based on one or more parameters of the current formulation. For example, in some embodiments, the dynamic component list 310 may be configured to display components from the selected category based on the frequency of use of the component with previously selected components. In some embodiments, the dynamic component list 310 may be configured to display one or more components from the selected category based on a formulation requirement defined by the user. In the illustrated embodiment, the dynamic component list 310 is configured to display components from the selected component category based on the frequency of use of the component. Because no other components have been selected, the dynamic component list 310 displays all of the components for the selected category of isocyanates listed by general frequency of use in all formulations. In some embodiments, the component selection screen 300 may comprise a search box 312. The search box 312 may be configured to allow a user to search for a specific component by a known identifier, such as, for example, by name and/or chemical code.

In some embodiments, the component selection screen 300 may comprise a context specific information section 316. The context specific information section 316 may be configured to display enhanced context specific information based on the formulation and/or selected components. The enhanced context specific information section 316 may be configured to display, for example, enhanced context specific information such as descriptions of selected components and/or formulations, inventory information about selected components, usage information about selected components and/or formulations, chemical structure information, and/or additional enhanced context specific information. In the illustrated embodiment, the user has not selected any components and the context specific information section 316 displays component information about the component selected in the component selection list 302. The enhanced context-specific information may be organized in one or more tabs 318a-318b.

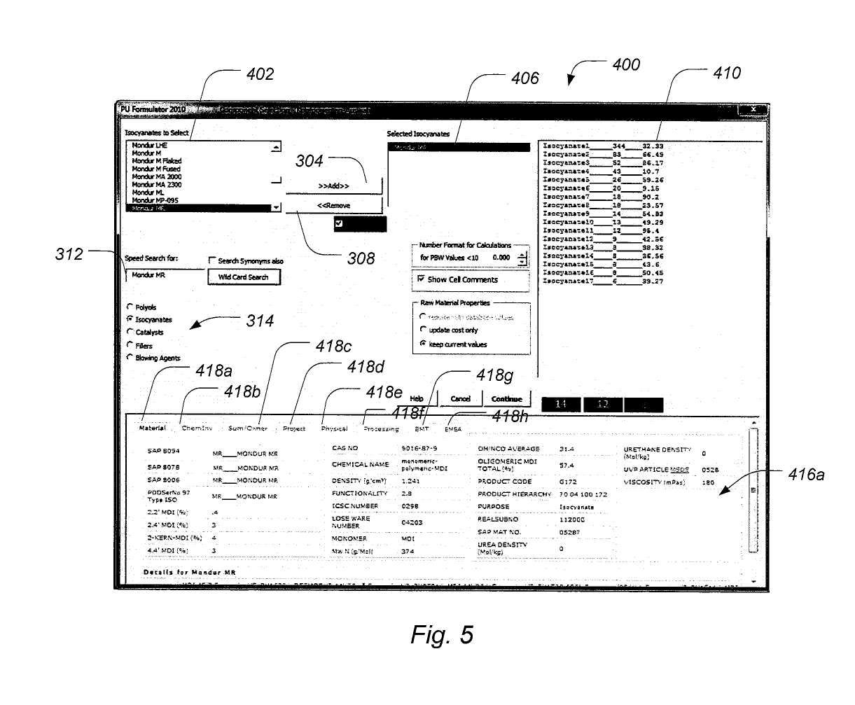

In some embodiments, a user may select a component from the component selection list 302 and/or the dynamic component list 310. For example, a user may select a component from the dynamic component list 310 by double-clicking on a component displayed in the dynamic component list 310. FIG. 5 illustrates one embodiment of a component selection screen 400 after a user has selected a first component. Once a user selects a component, for example, an isocyanate, the selected isocyanate is displayed in the selected isocyanates list 406. In some embodiments, the selection of a component may cause the dynamic component list 410 to update. FIG. 5 illustrates one embodiment of a dynamic component list 410 updated based on the selection of MONDUR MR polyisocyanate (commercially available from Bayer MaterialScience). The dynamic component list 410 may be configured to display only isocyanates that have been used in one or more formulations with MONDUR MR polyisocyanate. The dynamic component list 410 may be arranged, for example, by frequency of use of the listed components with the previously selected components, for example, MONDUR MR polyisocyanate. In some embodiments, the dynamic component list 410 may be arranged by a user selected parameter, such as, for example, alphabetically.

In some embodiments, the enhanced context-specific information section 416 may be updated based on the selected component. The enhanced context-specific information section 416 may be updated to display context specific information related to the MONDUR MR polyisocyanate selected by the user. One or more information tabs 418a-418h may be configured to display context specific information related to the selected components. A component information tab 418a may be configured to display component information related to a selected component, such as, for example, chemical definition details of a component selected by the user, for example, from the component selection list 402.

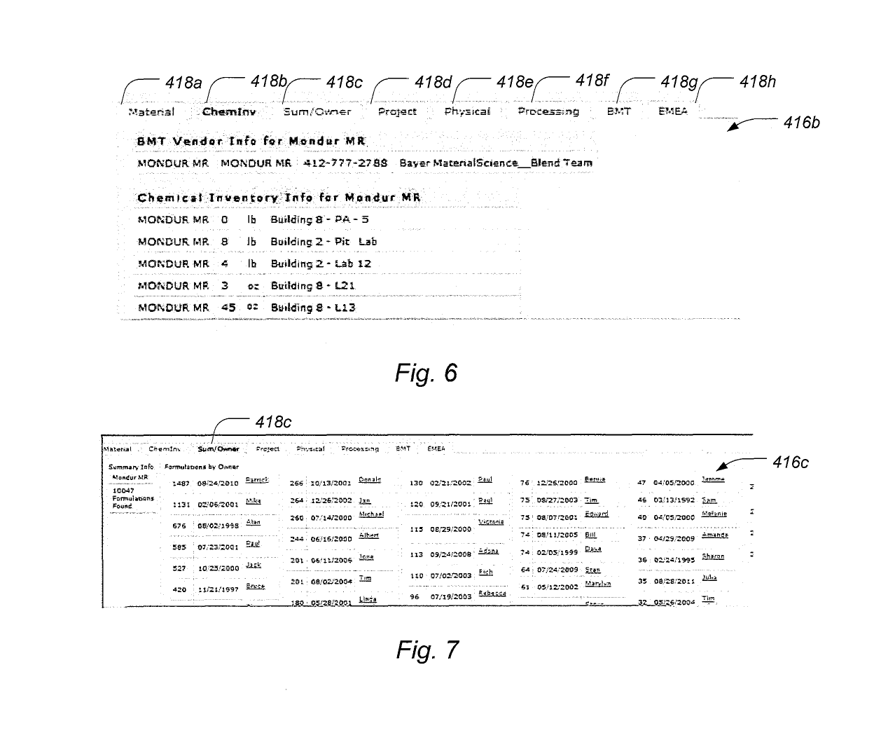

The one or more information tabs 418a-418h may be configured to display enhanced context specific information. For example, an inventory tab 418b may be configured to display inventory information related to the selected component. FIG. 6 illustrates one embodiment of an inventory tab 418b configured to display a component information screen 416b comprising inventory information related to MONDUR MR polyisocyanate. In some embodiments, the component inventory information screen 416b may be configured to identify the location, quantity, and availability of the selected component(s).

In some embodiments, a formulation ownership tab 418c may be configured to display a list of users who have used the selected component in formulations. FIG. 7 illustrates one embodiment of a formulation ownership tab 418c configured to display a list of users 416c associated with formulations containing the selected component, MONDUR MR polyisocyanate. The list of users 416c may be arranged by, for example, the number of formulations including the selected component associated with the user and/or alphabetically. In some embodiments, a project ownership tab 418d may be configured to display a list of formulations utilizing the selected component. The list may be similar to the list of users 416c shown in FIG. 7.

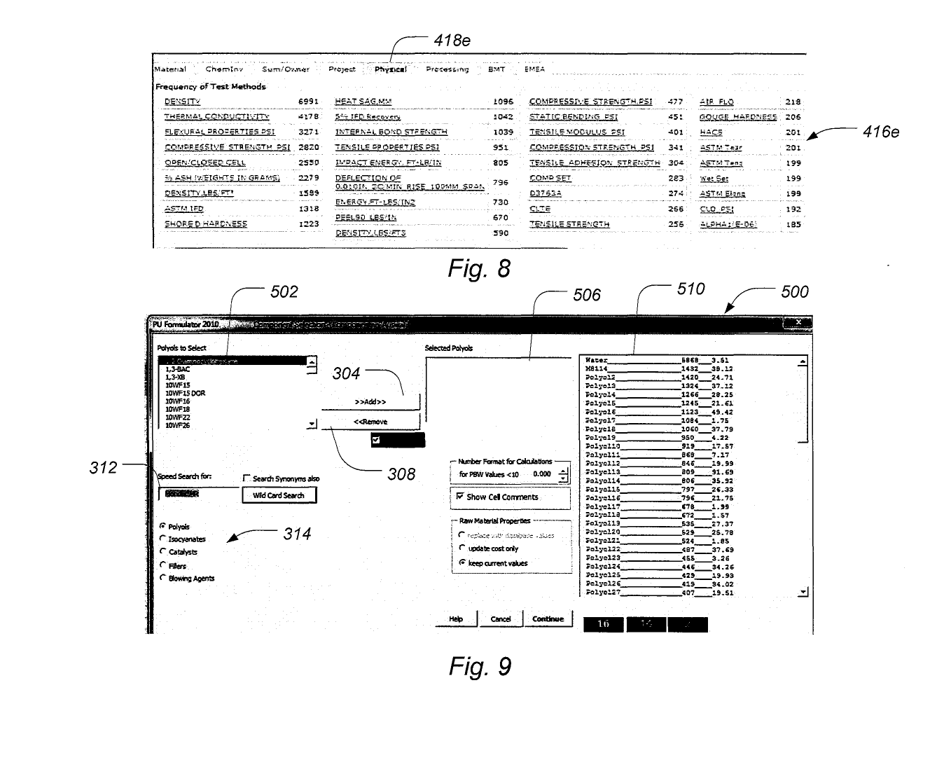

A physical properties tab 418e is configured to display physical properties of the selected component and/or formulation. FIG. 8 illustrates one embodiment of a physical properties tab 418e configured to display a list of physical properties related to formulations containing the selected component(s). In some embodiments, the physical properties may be determined through, for example, internal testing within an organization. In some embodiments, the physical properties may identify common and/or appropriate uses for selected components and/or component combinations. For example, in the illustrated embodiment, the thermal conductivity number indicates that MONDUR MR polyisocyanate may be good for developing insulation formulations.

In some embodiments, a processing information tab 418f is configured to provide enhanced context-specific information related to the processing of formulations including the selected components. Processing information may comprise, for example, mold time, curing time, temperatures, pressure measurements, and/or other processing specific information. An internal use tab 418g is configured to provide institution specific information relating to the uses of a selected component within the institution. For example, the internal use tab 418g may be configured to identify one or more individuals within an organization who have submitted requests for a selected component within a specific time period, such as, for example, the last twelve months. An international use tab 418h is configured to identify individuals outside of a business unit or organization who have used the selected components. For example, in one embodiment, the international use tab 418h may be configured to identify employees of an organization outside of a specific country, such as, for example, the United States, who have used the selected components and may identify restrictions on those individuals, such as, for example, export controls or procedures.

FIG. 9 illustrates one embodiment of a polyol component selection screen 500. The user may select a polyol from the component category list 314. The advisor recipe development system may display the polyol component selection screen 500 based on the selection of the polyols category. The component selection list 502 may be updated to display, for example, all polyols stored by the advisor recipe development system. In some embodiments, the dynamic component list 510 may be updated to display components classified as polyols. The dynamic component list 510 may be limited to polyols used in formulations with the previously selected components. For example, in the illustrated embodiment, the user has previously selected MONDUR MR polyisocyanate as an isocyanate. The dynamic component list 510 is configured to display polyols that have been used in formulations in conjunction with MONDUR MR polyisocyanate. In some embodiments, the dynamic component list 510 may be organized by frequency of use between the listed polyol and the previously selected components.

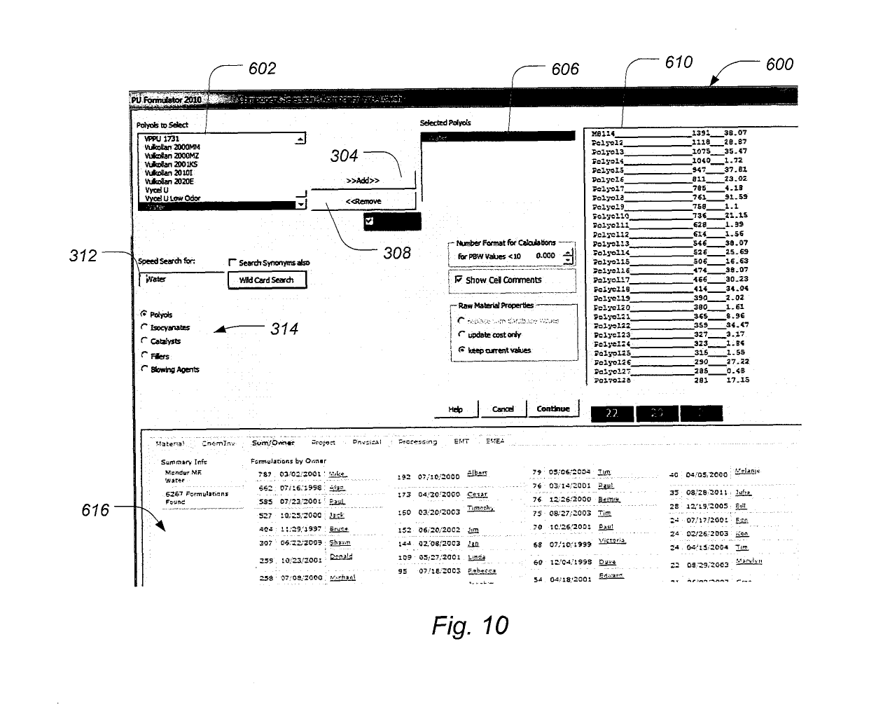

A user may select a polyol from the component selection list 502 and/or from the dynamic component list 510. In one embodiment, a user may select Water as a polyol. FIG. 10 illustrates one embodiment of a component selection screen 600 updated based on the selection of Water as a polyol. Water is listed in the selected polyol list 606. The dynamic component list 610 is updated based on the selection of both MONDUR MR polyisocyanate and Water as components in the formulation. The components listed in the dynamic component list 610 may comprise polyols that have been used in formulations comprising both MONDUR MR polyisocyanate and Water. In some embodiments, the dynamic component list 610 may be sorted by frequency of use of the listed polyols in formulations containing both MONDUR MR polyisocyanate and Water.

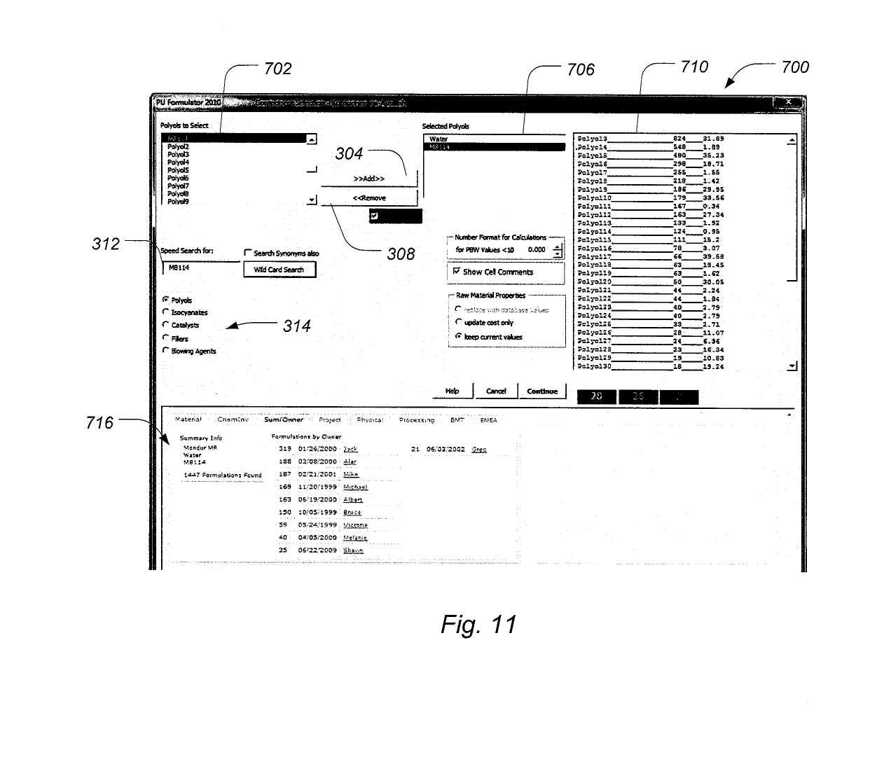

In some embodiments, a user may select a second polyol for inclusion in the formulation. For example, as shown in FIG. 11, a user may select a second polyol, such as, for example, MULTRANOL M8114 polyether polyol (commercially available from Bayer MaterialScience), which is received by the processor. The component selection screen 700 is updated to reflect the selection of MULTRANOL M8114 polyether polyol as a second polyol. The dynamic component list 710 is updated to display only those polyols used in formulations with MONDUR MR polyisocyanate, Water, and MULTRANOL M8114 polyether polyol. The context specific information section 716 is updated to provide information related to formulations including MONDUR MR polyisocyanate, Water, and MULTRANOL M8114 polyether polyol. For example, the physical and processing property tabs may be updated to provide average physical properties and processing information for formulations containing each of the selected components.

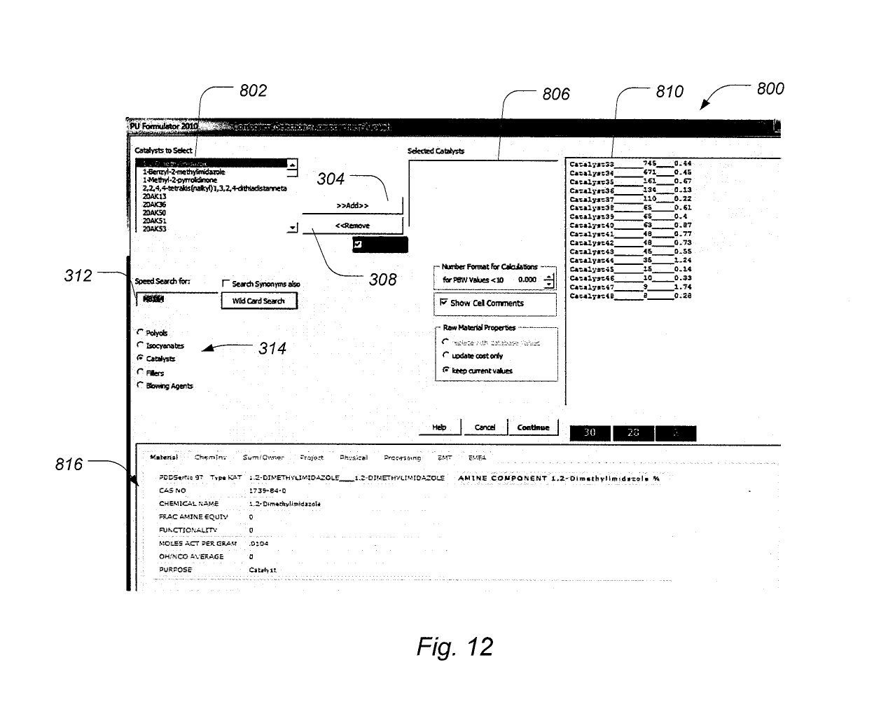

A user may select a new category of components, for example, catalyst, from the components category list 314. FIG. 12 illustrates one embodiment of a component selection screen 800 configured to display components classified as catalyst. The component selection list 802 may be updated to display all components in the system that is stored as catalyst. A selected catalysts list 806 may be configured to display one or more catalyst selected for inclusion in the formulation. The dynamic component list 810 may be updated to display catalysts that have been previously used in formulations with the selected components. A user may add one or more catalyst to the formulation from the component selection list 802 and/or the dynamic component list 810. The context specific information section 816 may be updated to display information related to components and/or formulations comprising each of the selected components.

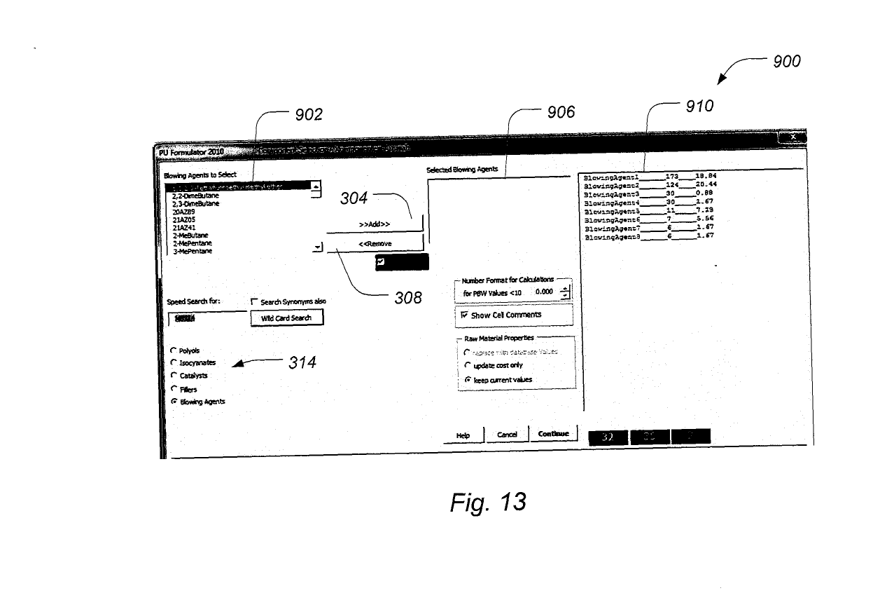

A user may select a different category of components, such as, for example, blowing agents, from the components category list 314. FIG. 13 illustrates one embodiment of a component selection screen 900 configured to display one or more components classified as blowing agents. The component selection list 902 may be updated to display all components classified by the system as blowing agents. A selected blowing agents list 906 may display one or more blowing agents selected by the user for inclusion in the formulation. The dynamic component list 910 may be updated to display blowing agents that have been used in formulations with the previously selected components. For example, the dynamic component list 910 may be limited to only those blowing agents that have been used in formulations comprising MONDUR MR polyisocyanate, Water, and MULTRANOL M8114 polyether polyol.

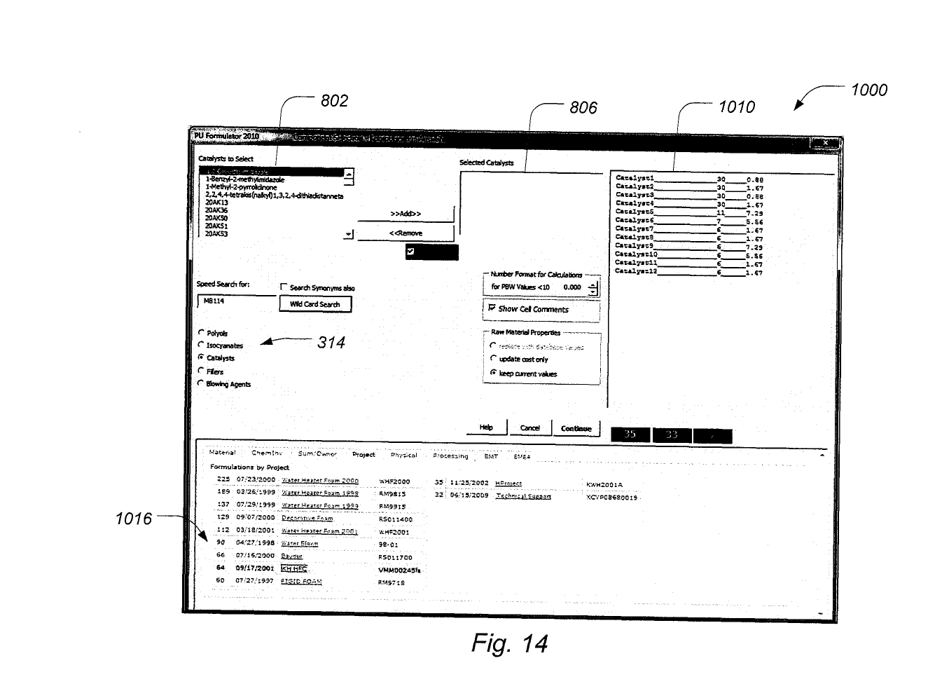

In some embodiments, the dynamic component list 910 may be updated based on the selection of one or more items from the context specific information section. For example, in one embodiment illustrated in FIG. 14, a user may select a project from the project tab 318d. The advisor recipe development system may limit the dynamic component list 1010 to catalysts used in the selected project. The user may select, for example, a WH HFC project from the context specific information section 1016. The dynamic component list 1010 may be configured to display only the catalyst used in the WH HFC project. In some embodiments, the user may limit the dynamic component list 1010 based on the selection of any information in the enhanced context-specific information section.

FIG. 15 shows one embodiment of a computing device 1100 which can be used in one embodiment of the advisor recipe development system and method. For the sake of clarity, the computing device 1100 is shown and described here in the context of a single computing device. It is to be appreciated and understood, however, that any number of suitably configured computing devices can be used to implement any of the described embodiments. For example, in at least some implementation, multiple communicatively linked computing devices are used. One or more of these devices can be communicatively linked in any suitable way such as via one or more networks (LANs), one or more wide area networks (WANs) or any combination thereof.

In this example, the computing device 1100 comprises one or more processor circuits or processing units 1102, on or more memory circuits and/or storage circuit component(s) 1104 and one or more input/output (I/O) circuit devices 1106. Additionally, the computing device 1100 comprises a bus 1108 that allows the various circuit components and devices to communicate with one another. The bus 1108 represents one or more of any of several types of bus structures, including a memory bus or local bus using any of a variety of bus architectures. The bus 1108 may comprise wired and/or wireless buses.

The processing unit 1102 may be responsible for executing various software programs such as system programs, applications programs, and /or module to provide computing and processing operations for the computing device 1100. The processing unit 1102 may be responsible for performing various voice and data communications operations for the computing device 1100 such as transmitting and receiving voice and data information over one or more wired or wireless communication channels. Although the processing unit 1102 of the computing device 1100 includes single processor architecture as shown, it may be appreciated that the computing device 1100 may use any suitable processor architecture and/or any suitable number of processors in accordance with the described embodiments. In one embodiment, the processing unit 1100 may be implemented using a single integrated processor.

The processing unit 1102 may be implemented as a host central processing unit (CPU) using any suitable processor circuit or logic device (circuit), such as a general purpose processor. The processing unit 1102 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the processing unit 1102 may be coupled to the memory and/or storage component(s) 1104 through the bus 1108. The memory bus 1108 may comprise any suitable interface and/or bus architecture for allowing the processing unit 1102 to access the memory and/or storage component(s) 1104. Although the memory and/or storage component(s) 1104 may be shown as being separate from the processing unit 1102 for purposes of illustration, it is worthy to note that in various embodiments some portion or the entire memory and/or storage component(s) 1104 may be included on the same integrated circuit as the processing unit 1102. Alternatively, some portion or the entire memory and/or storage component(s) 1104 may be disposed on an integrated circuit or other medium (e.g., hard disk drive) external to the integrated circuit of the processing unit 1102. In various embodiments, the computing device 1100 may comprise an expansion slot to support a multimedia and/or memory card, for example.

The memory and/or storage component(s) 1104 represent one or more computer-readable media. The memory and/or storage component(s) 1104 may be implemented using any computer-readable media capable of storing data such as volatile or non-volatile memory, removable or non-removable memory, erasable or non-erasable memory, writeable or re-writeable memory, and so forth. The memory and/or storage component(s) 1104 may comprise volatile media (e.g., random access memory (RAM)) and/or nonvolatile media (e.g., read only memory (ROM), Flash memory, optical disks, magnetic disks and the like). The memory and/or storage component(s) 1104 may comprise fixed media (e.g., RAM, ROM, a fixed hard drive, etc.) as well as removable media (e.g., a Flash memory drive, a removable hard drive, an optical disk, etc.). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 1106 allow a user to enter commands and information to the computing device 1100, and also allow information to be presented to the user and/or other components or devices. Examples of input devices include a keyboard, a cursor control device (e.g., a mouse), a microphone, a scanner and the like. Examples of output devices include a display device (e.g., a monitor or projector, speakers, a printer, a network card, etc.). The computing device 1100 may comprise an alphanumeric keypad coupled to the processing unit 1102. The keypad may comprise, for example, a QWERTY key layout and an integrated number dial pad. The computing device 1100 may comprise a display coupled to the processing unit 1102. The display may comprise any suitable visual interface for displaying content to a user of the computing device 2000. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 1102 may be arranged to provide processing or computing resources to the computing device 1100. For example, the processing unit 1102 may be responsible for executing various software programs including system programs such as operating system (OS) and application programs. System programs generally may assist in the running of the computing device 1100 and may be directly responsible for controlling, integrating, and managing the individual hardware components of the computer system. The operating system (OS) may be implemented, for example, as a MICROSOFT WINDOWS OS, SYMBIAN OS, EMBEDIX OS, LINUX OS, Binary Run-time Environment for Wireless (BREW) OS, JAVA OS, ANDROID OS, APPLE OS or other suitable operating system (OS) in accordance with the described embodiments. The computing device 1100 may comprise other system programs such as device drivers, programming tools, utility programs, software libraries, application programming interfaces (APIs), and so forth.

The computer 1100 also includes a network interface 1110 coupled to the bus 1108. The network interface 1110 provides a two-way data communication coupling to a local network 1112. For example, the network interface 1110 may be a digital subscriber line (DSL) modem, satellite dish, an integrated services digital network (ISDN) card or other data communication connection to a corresponding type of telephone line. As another example, the communication interface 1110 may be a local area network (LAN) card effecting a data communication connection to a compatible LAN. Wireless communication means such as internal or external wireless modems may also be implemented.

In some embodiments, the network interface 1110 connects the computer 1100 to one or more databases and/or data repositories. The network interface 1110 may utilize one or more communication protocols, such as, for example, Transmission Control Protocol and Internet Protocol (TCP/IP), User Datagram Protocol (UDP), File Transfer Protocol (FTP), Hypertext Transfer Protocol (HTTP), Hypertext Transfer Protocol Secure (HTTPS), and/or any other communication protocol. In one embodiment, the network interface 1110 utilizes secure TCP/IP sockets and a HTTPS protocol to provide encrypted and highly-secure two-way data transfer. Those skilled in the art will recognize that any suitable combination of protocols may be used to communication with remote systems and/or data repositories.

In some embodiments, the network interface 1110 provides authentication of each request for a communication exchange. For example, the network interface 1110 may provide authentication by verifying WINDOWS logged in user information, WINDOWS challenge/response (NTLM) authentication, Kerberos challenge/response authentication, and/or any other type of authentication. In various embodiments, the authentication of each request for a communication exchange may comprise a manual authentication or automatic authentication. In other embodiments, authentication of each request is not performed. Authentication of user requests for a communication exchange to allow the network interface 1110, a remote system, and/or a data repository to tailor a response to the requests for communication exchange.

In any such implementation, the network interface 1110 sends and receives electrical, electromagnetic or optical signals that carry digital data streams representing various types of information, such as the selection of a component, enhanced context specific information, or a list of components. The network interface 1110 typically provides data communication through one or more networks to other data devices. For example, the network interface 1110 may effect a connection through the local network to an Internet Host Provider (ISP) or to data equipment operated by an ISP. The ISP in turn provides data communication services through the internet (or other packet-based wide area network). The local network and the internet both use electrical, electromagnetic or optical signals that carry digital data streams. The signals through the various networks and the signals on the network interface 1110, which carry the digital data to and from the computer system 1100, are exemplary forms of carrier waves transporting the information.

The computer 1100 can send messages and receive data, including program code, through the network(s) and the network interface 1110. In the Internet example, a server might transmit a requested code for an application program through the internet, the ISP, the local network (the network 1112) and the network interface 1110. In accordance with the invention, one such downloaded application provides for advisor recipe development. The received code may be executed by processor 1104 as it is received, and/or stored in storage device 1110, or other non-volatile storage for later execution. In this manner, computer 1100 may obtain application code in the form of a carrier wave.

Various embodiments may be described herein in the general context of computer executable instructions, such as software, program modules, and/or engines being executed by a computer. Generally, software, program modules, and/or engines include any software element arranged to perform particular operations or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, program modules, and/or engines may be located in both local and remote computer storage media including memory storage devices.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general purpose processor or application specific processor. The embodiments, however, are not limited in this context.

The functions of the various functional elements, logical blocks, modules, and circuits elements described in connection with the embodiments disclosed herein may be implemented in the general context of computer executable instructions, such as software, control modules, logic, and/or logic modules executed by the processing unit. Generally, software, control modules, logic, and/or logic modules comprise any software element arranged to perform particular operations. Software, control modules, logic, and/or logic modules can comprise routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

Various aspects of the subject matter described herein are set out in the following numbered clauses:

1. A computer-implemented method for advisor recipe development, the method comprising: receiving, by a processor, a first component; and identifying, by the processor, enhanced context specific information based on the first component.

2. The computer-implemented method according to clause 1, further comprising identifying, by the processor, one or more additional components based on the first component, wherein the enhanced context specific information comprises the one or more additional components.

3. The computer-implemented method according to clause 2, wherein the one or more additional components comprise components used in conjunction with the first component in one or more existing formulations.

4. The computer-implemented method according to any one of clauses 1 to 3, comprising identifying, by the processor, component information relevant to the first component, wherein the enhanced context specific information comprises the component information.

5. The computer-implemented method according to any one of clauses 1 to 4, comprising identifying, by the processor, primary information related to formulations containing the first component, wherein the enhanced context specific information comprises the primary information.

6. The computer-implemented method according to clause 5, wherein the primary information related to formulations comprising the first component comprises at least one of processing and performance metrics, formulation development objectives, statistical moments of the data, or any combination thereof.

7. The computer-implemented method according to clause 5, comprising identifying, by the processor, secondary information related to the first component, wherein the enhanced context specific information comprises the secondary information.

8. The computer-implemented method according to clause 7, wherein the secondary information related to the first component comprises at least one of scale-up trials, commercial products, detailed support documents, or any combination thereof.

9. An advisor recipe development system comprising: a processor; and a non-transitory computer-readable medium coupled to the processor, the non-transitory computer-readable medium configured to store computer program instructions that when executed by the processor is operable to cause the processor to: receive a selection of a first component; and identify enhanced context specific information based on the first component.

10. The advisor recipe development system according to clause 9, wherein the enhanced context specific information comprises one or more additional components identified based on the selection of the first component.

11. The advisor recipe development system according to clause 10, wherein the one or more additional components comprise components used in conjunction with the first component in one or more existing formulations.

12. The advisor recipe development system according to any one of clauses 9 to 11, wherein the enhanced context specific information comprises component information relevant to the first component.

13. The advisor recipe development system according to any one of clauses 9 to 12, wherein the enhanced context specific information comprises primary information related to formulations containing the first component.

14 The advisor recipe development system according to clause 13, wherein the primary information comprises at least one of processing and performance metrics, formulation development objectives, statistical moments of the data, or any combination thereof.

15. The advisor recipe development system according to clause 13, wherein the enhanced context specific information comprises secondary information related to the first component.

16. The advisor recipe development system according to clause 15, wherein the secondary information comprises at least one of scale-up trials, commercial products, detailed support documents, or any combination thereof.

17. A computer-implemented method for advisor recipe development, the method comprising: receiving, by a processor, a first component; receiving, by the processor, a second component; and identifying, by the processor, enhanced context specific information based on the first component and the second component.

18. The computer-implemented method according to clause 17, comprising: receiving, by the processor, one or more additional components; and updating, by the processor, the enhanced context specific information based on the one or more additional components.

19. The computer-implemented method according to clause 18, wherein the enhanced context specific information comprises a list of components previously used in one or more formulations with the first component, the second component, and the one or more additional components.

20. The computer-implemented method according to clause 18, wherein the enhanced context specific information comprises primary information related to formulations containing the first component, the second component, and the one or more additional components.

21. The computer-implemented method according to clause 18, wherein the primary information comprises at least one of processing and performance metrics, formulation development objectives, statistical moments of the data, or any combination thereof.

22. The computer-implemented method according to clause 18, wherein the enhanced context specific information comprises secondary information related to the first component, the second component, and the one or more additional components.

23. The computer-implemented method according to clause 18, wherein the secondary information comprises at least one of scale-up trials, commercial products, detailed support documents, or any combination thereof.

What is claimed is:

1. A computer-implemented method for advisor recipe development, the method comprising:
receiving, by a processor, a first component; and
identifying, by the processor, enhanced context specific information based on the first component.

2. The computer-implemented method according to claim 1, further comprising identifying, by the processor, one or more additional components based on the first component, wherein the enhanced context specific information comprises the one or more additional components.

3. The computer-implemented method according to claim 2, wherein the one or more additional components comprise components used in conjunction with the first component in one or more existing formulations.

4. The computer-implemented method according to claim 1, comprising identifying, by the processor, component information relevant to the first component, wherein the enhanced context specific information comprises the component information.

5. The computer-implemented method according to claim 1, comprising identifying, by the processor, primary information related to formulations containing the first component, wherein the enhanced context specific information comprises the primary information.

6. The computer-implemented method according to claim 5, wherein the primary information related to formulations comprising the first component comprises at least one of processing and performance metrics, formulation development objectives, statistical moments of the data, or any combination thereof.

7. The computer-implemented method according to claim 5, comprising identifying, by the processor, secondary information related to the first component, wherein the enhanced context specific information comprises the secondary information.

8. The computer-implemented method according to claim 7, wherein the secondary information related to the first component comprises at least one of scale-up trials, commercial products, detailed support documents, or any combination thereof.

9. An advisor recipe development system comprising:
a processor; and
a non-transitory computer-readable medium coupled to the processor, the non-transitory computer-readable medium configured to store computer program instructions that when executed by the processor are operable to cause the processor to:
receive a selection of a first component; and
identify enhanced context specific information based on the first component.

10. A computer-implemented method for advisor recipe development, the method comprising:
receiving, by a processor, a first component;
receiving, by the processor, a second component; and
identifying, by the processor, enhanced context specific information based on the first component and the second component.

11. The computer-implemented method according to claim 10, comprising:
receiving, by the processor, one or more additional components; and
updating, by the processor, the enhanced context specific information based on the one or more additional components.

12. The computer-implemented method according to claim 11, wherein the enhanced context specific information comprises a list of components previously used in one or more formulations with the first component, the second component, and the one or more additional components.

13. The computer-implemented method according to claim 11, comprising identifying, by the processor, primary information related to formulations containing the first component, the second component, and the one or more additional components wherein the enhanced context specific information comprises the primary information.

14. The computer-implemented method according to claim 11, wherein the primary information related to formulations comprising the first component, the second component, and the one or more additional components comprises at least one of processing and performance metrics, formulation development objectives, statistical moments of the data, or any combination thereof.

15. The computer-implemented method according to claim 11, comprising identifying, by the processor, secondary information related to the first component, the second component, and the one or more additional components, wherein the enhanced context specific information comprises the secondary information.

16. The computer-implemented method according to claim 11, wherein the secondary information related to the first component, the second component, and the one or more additional components comprises at least one of scale-up trials, commercial products, detailed support documents, or any combination thereof.
